(19) United States
(12) Patent Application Publication
(10) Pub. No.: US 2005/0185070 A1
(43) Pub. Date: Aug. 25, 2005

(54) Image capture

(76) Inventor: Stephen Philip Cheatle, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/046,609

(22) Filed: Jan. 28, 2005

(30) Foreign Application Priority Data
Jan. 30, 2004 (GB) 0401994.9

(51) Int. Cl. H04N 5/262

(52) U.S. Cl. 348/239

(57) ABSTRACT

An image capture device having a panorama mode for processing images captured using a panoramic sweep of the device, in which mode an extent of a capturable image presented for viewing by a user is limited laterally of an axis of intended sweep.

### CLAIM TO PRIORITY

This application claims priority to copending United Kingdom utility application entitled, “IMAGE CAPTURE,” having serial no. GB 0401994.9, filed Jan. 30, 2004, which is entirely incorporated herein by reference.

### TECHNICAL FIELD

The present invention relates to the field of image capture.

### BACKGROUND

There are various known methods by which a panoramic image of an object or scene may be captured or generated. These range from, for example, expensive professional systems capable of producing 360° panoramas, to methods which ‘stitch’ together a plurality of captured images in order to generate a final panoramic image.

Such stitching techniques may be applied to a sequence of images or to a video sequence obtained using an image capture device such as a camera or video-camera, digital or non-digital or any other suitable device, and rely on sufficient overlapping of adjacent image frames in order that frames may be accurately stitched (or overlaid) to provide a final panoramic image. However, in order to ensure this overlapping, effort is required on the part of the photographer when capturing a sequence of images with an image capture device, which sequence is to be used for the panorama generation.

Numerous aids have been provided in order to assist users in aligning adjacent images for the purposes of providing a sequence of images for use with an image stitching system. For example, half of the previous image may be shown in an electronic viewfinder and overlaid over the current viewfinder image. For example, U.S. Pat. No. 5,682,197 describes the use of markers in a viewfinder in order to aid user-alignment of frames.

Although the above framing aid is useful for judging the overlap between adjacent image frames of a sequence for the purposes of generating a panoramic image, it does not prevent vertical drift of an image capture device over the sequence of frames. This is a common problem when a plurality of images are captured in succession in order to generate a panoramic image, due to the natural tendency of a photographer to deviate from a desired direction of pan such that a curved path is followed as the device is moved.

FIG. 1 is an example of a panoramic image 100 obtained by stitching (manually or automatically) a plurality of captured images 102 together using known techniques. FIG. 1 illustrates the vertical drift problem associated with generating panoramic images when such a sequence of images is used. More specifically, it is apparent that as the device used to capture the sequence of images comprising the panorama has been moved from left to right, it has also been moved upwards slightly following each image frame. More specifically, it has been moved slightly in a direction generally perpendicular, or lateral, to the direction of pan, or sweep, of the device.

Areas 103, 104 of FIG. 1 are blank image areas which are devoid of image data. More specifically, when a panoramic image is generated from a sequence of images, as has been done in FIG. 1, drift of the image capture device used to capture the sequence causes blank areas to be present in the rectangular area defining the panorama such as areas 103, 104 of FIG. 1. One solution to this problem is to crop the generated panoramic image in order to produce a fully defined rectangular panoramic image with no blank areas devoid of image data such as the panorama 200 as depicted in FIG. 2. In the panorama 200 of FIG. 2, significant portions of the original panoramic image have been clipped in order to provide a fully defined rectangular image with no blank regions. More specifically, areas 201, 203 are missing from the panoramic image 200 as these areas have been clipped in order to produce a fully defined image devoid of the blank regions 205, 207. This may cause important parts of a panorama (such as the tops of mountains for example) to be clipped, which may be undesirable to the user.

Several further solutions to the vertical drift problem are known in addition to clipping the generated panorama as described above. For example, a user may set an image capture device up on a tripod in order to ensure that the device is level with respect to the scene or object to be captured. Although this may prove acceptable for a professional photographer, the vast majority of domestic photographers are not prepared to carry a tripod, or to spend the time setting the tripod up.

Alternatively, a user of an image capture device may use a wider angle when capturing a panorama by using a wider angle lens for example, thereby enabling the resulting panoramic image to be manually cropped. However, many users will not be aware of the need to use a wider angle and/or not be willing or have time to manually crop the resultant panoramic image.

Further alternatively, a user may use a manual photo-editing tool in an attempt to manually replace any pixels missing from a panoramic image as a result of a cropping process by painting them in, for example. This is, however, a time consuming process, and is far from desirable as any image areas which are replaced manually will almost inevitably not resemble the originally captured image area exactly.

### SUMMARY

According to an aspect of the present invention there is provided an image capture device having a panorama mode for processing images captured using a panoramic sweep of the device, in which mode an extent of a capturable image presented for viewing by a user is limited laterally of an axis of intended sweep.

According to a further aspect of the present invention, there is provided a method of using an image capture device, the method comprising reducing a viewfinder field of view of the device in a dimension generally perpendicular to a direction of pan of the device.

According to a further aspect of the present invention there is provided an image capture device including a panoramic image generation mode, said device including means for limiting an extent of a capturable image presented for viewing by a user laterally of an axis of intended sweep when the device is in said panoramic image generation mode.

According to a further aspect of the present invention there is provided a method of using an image capture device having a panorama mode in which mode an extent of a capturable image adapted to be presented for viewing by a user is limited laterally of an axis of intended sweep, the method including processing images captured using a panoramic sweep of the device.

### BRIEF DESCRIPTION OF THE FIGURES

For a better understanding of the present invention, and to further highlight the ways in which it may be brought into effect, various embodiments will now be described, by way of example only, with reference to the following drawings in which:—

FIG. 1 is a diagrammatic representation of a panoramic image illustrating the potential problems associated with prior art devices;

FIG. 2 is a diagrammatic representation of the prior art panoramic image of FIG. 1 following clipping of undefined images areas;

FIGS. 3a and 3b are diagrammatic representations of a viewfinder field of view of an image capture device;

FIG. 4 is a diagrammatic representation of an image capture device;

FIG. 5 is a diagrammatic representation of a panoramic image;

FIG. 6 is a further diagrammatic representation of a panoramic image;

FIG. 7 is a further diagrammatic representation of a panoramic image;

FIG. 8 is a further diagrammatic representation of a panoramic image; and

FIG. 9 is a flow chart of a process employed by various embodiments.

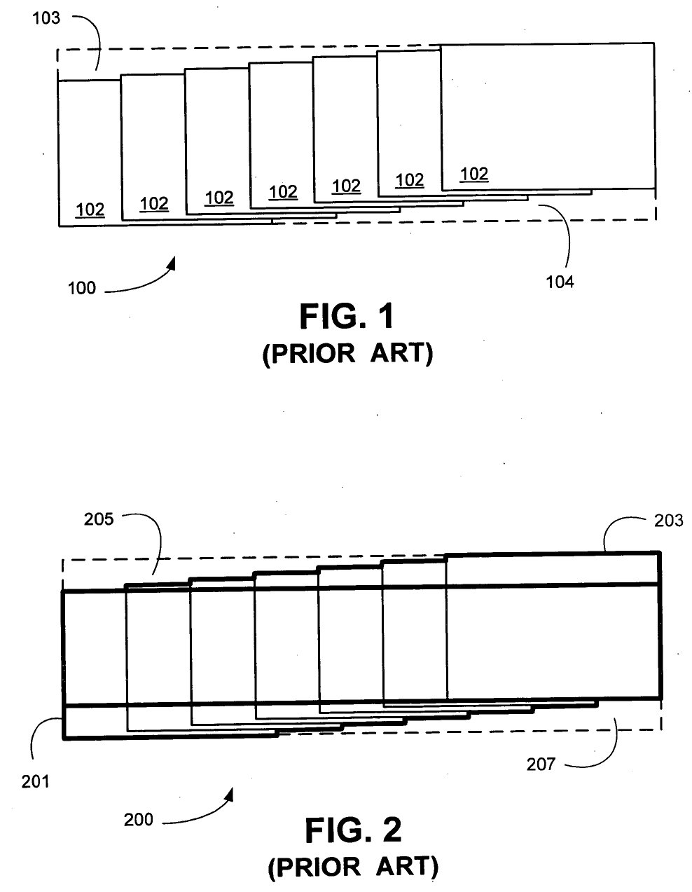

It should be emphasised that the term “comprises/comprising” when used in this specification specifies the presence of stated features, integers, steps or components but does not preclude the presence or addition of one or more other features, integers, steps, components or groups thereof.

### DETAILED DESCRIPTION

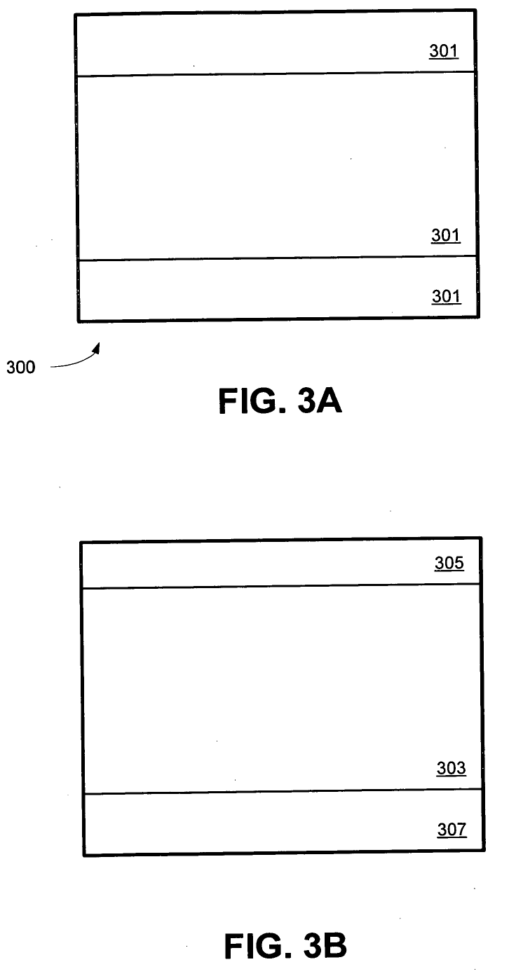

FIG. 3a of the accompanying drawings represents an embodiment in which a viewfinder field of a view 300 of an image capture device (not shown) may be reduced. A viewfinder provides a means on the image capture device operable to indicate, either optically or electronically, image data which will appear in the field of view of the lens of the device. More specifically, FIG. 3a represents the view seen by a user of an image capture device when looking through an optical viewfinder of the device. Area 301 is the viewfinder field of view as seen by a user of the device.

In FIG. 3a, a vertical, in the orientation shown in FIG. 3a, viewfinder field of view has been reduced to that represented by area 301 by mechanically masking portions 301 of the viewfinder field of view of the device such that the final viewfinder image is limited. It will be appreciated that, if desirable, a horizontal reduction in the viewfinder field of view may take place in addition, or as an alternative to, the vertical reduction. The reduction as shown in FIG. 3a is appropriate if the image capture device is to be swept in a substantially horizontal direction during capture of a sequence of images.

Accordingly, a viewfinder field of view of a device is limited in order to allow a user to be able to select salient parts of an object/scene to be captured without any loss in relevant areas of captured image data following generation of a panoramic image from the captured image data.

It will be appreciated that the manner of implementing a reduction in a viewfinder field of view may differ from that shown in the figures. For example, the reduction may be effected by obscuring, or reducing the intensity of only one portion of a viewfinder field of view such that a substantially asymmetrical reduction in the viewfinder field of view is effected. In the case of the optical viewfinder of FIG. 3a, a reduction in intensity of a portion of the viewfinder field of view may be effected by inserting, for example, a transparent liquid crystal display (LCD) somewhere between a lens of the device and the viewfinder. A suitably programmed microprocessor of the device may then be operable to turn certain portions of the LCD opaque in order that light is prevented from being transmitted through it to the viewfinder. For example, the processor may be operable to turn a portion, or portions, of the LCD into a ‘checkerboard’ pattern with alternating opaque and transparent areas. In this way, the intensity of light transmitted though the LCD to the viewfinder will be effectively reduced. Alternative patterns are possible.

Alternatively, and in a preferred embodiment, a viewfinder field of view of a device with an optical viewfinder is limited using an opaque element or elements which are operable to obscure at least a portion of a viewfinder field of view.

In the embodiment of FIG. 3b, image data from an image capture element of an image capture device (not shown) is processed prior to being viewed in an electronic viewfinder of the device in order to provide the reduced viewfinder field of view. More specifically, a vertical (in the orientation shown in the figure) viewfinder field of view has been reduced in order to provide an effective viewfinder field of view in the viewfinder of a device represented by the area 303. The image capture element of the device could be a charge-coupled device (CCD) or a complementary metal oxide semiconductor (CMOS) device, for example.

A user of the device may select a factor by which the viewfinder field of view is to be reduced via a menu system of the device or by using a selection button on the device, for example. Such a menu selection or selection button may provide the user with a plurality of fixed selection values corresponding to a viewfinder field of view reduction factor in the range of 10-50% in increments of 10% for example. Other ranges and increments are possible. It may also be desirable to provide an analogue selection button operable to provide a viewfinder field of view reduction factor of any value within in a particular range. Such a button may take the form of a rotary dial for example.

Alternatively, if appropriate, when a user places an image capture device into a panoramic capture mode of the device, a pre-set viewfinder field of view reduction factor may be applied to a viewfinder field of view by the device. The pre-set factor may be stored in a memory of the device. In this case, the user may be restricted from selecting the viewfinder field of view reduction factor, or alternatively, may have the option of overriding such a pre-set factor.

Alternatively, a suitably programmed microprocessor of the device (not shown) may be operable to process image data received from a capture element of the device in order to reduce the intensity of a portion or portions thereof. The level of intensity reduction may be pre-set in a memory of a device and/or may be adjusted manually by a user of the device.

Areas 305 and 307 of FIG. 3b represent areas in the viewfinder field of view of a preferred embodiment which have been limited, either by electronic masking of image data, or by a reduction in intensity compared to the intensity of the area defined by 303.

As an alternative to a viewfinder field of view masking or intensity reduction, a viewfinder zoom of a device may be used in order to limit a viewfinder field of view.

Once a reduction factor has been set, either by a user or the device, the factor may be stored in a header file of a captured image. For example, a captured image may use the Exchangeable Image File Format (EXIF). This format supports the storage of extended device information within the header of a JPEG file. Such extended information may include the date and time an image was captured for example, and may easily be extended to include additional fields relating to the factor by which the viewfinder field of view of the device was reduced during its capture. In this manner, the appropriate image data will be available in a device or on a computer after capture of images. The inclusion of such data may be important in determining the acceptability to a user of a panorama generated from captured images.

A sequence of images suitable for generating a panoramic image may be obtained using the reduced viewfinder field of view 301 or 303 of an image capture device.

The fields of view 301, 303 are the areas which a user of an image capture device uses, via the viewfinder of the device, in order to frame an object/scene for image capture. As an image is captured, and the device is moved through successive capture positions by the user, at least some of any drift resulting from the movement of a device perpendicular to the direction of panning as the device is moved is compensated for by the reduction in the viewfinder field of view in the relevant dimension. For example, the capture of a conventional panoramic scene will proceed by the capture of a sequence of images obtained by horizontally moving the image capture device and capturing images at numerous positions of the device, which images are then stitched together to form a panoramic image either in the image capture device itself, or at a later time using specialist software for generating such panoramas. Such image frames captured using a device in which the viewfinder field of view has been reduced by a certain factor in a substantially vertical dimension, that is, perpendicular, or lateral, to the direction in which the image capture device is panned or swept, will be framed differently by a user of the device than if the viewfinder field of view had not been reduced. The difference in framing results in a change to the image data captured thereby enabling salient areas to be retained later.

Salient areas of an object/scene when captured in this manner will therefore be framed in a visible portion of the viewfinder field of view, and any drift of a device may be compensated for using the effective ‘extra’ image data present in the masked areas, or areas of reduced intensity in the viewfinder field of view. This ‘extra’ data is always captured by the imaging element of the device, but will not always be visible to a user of the device. Accordingly, during a panoramic image generation process, undesirable movement of a device resulting in a potential loss of salient image data, such as the tops of mountains for example, can be compensated for using the image data relating to the masked or reduced intensity areas. Accordingly, when a viewfinder field of view of a device has been reduced, the image data relating to the areas not visible through a viewfinder of that device is not lost. The data remains available for manipulation, either within the device, or outside of it using a personal computer, for example. Accordingly, the reduction only restricts a viewfinder field of view, and not the amount of image data captured.

The stitching together of a sequence of images may proceed using known techniques. In particular, image data associated with a sequence of images to be stitched may be transformed using known perspective transformations into a transform space for stitching. Such a transform may be a trivial one- or two-dimensional mapping of images in the sequence in order to provide a stitched panorama, or may be a more complex transform (such as a transform into a cylindrical or spherical co-ordinate system) for example. Further alternatives are possible, and the method and system outlined herein will function using any suitable image stitching algorithm.

When a sequence of images is captured in this way, and when an image from the sequence is viewed post-capture, additional image data relating to the portions of the viewfinder field of view of the device which were reduced are therefore available for manipulation. These additional portions of image data enable the sequence to be stitched together in the device or outside of the device to form a panoramic image without any loss of image data from areas in the panorama due to drift of the device during capture.

The manipulation/processing of the captured image data may be performed on/in the device itself, either just after an image has been captured and stored in a memory of a device, or at a time subsequent to the capture and storage of the sequence. Alternatively, manipulation/processing may be performed ‘off-line’ using a computer or other suitable apparatus distinct from the capture device which is capable of image data manipulation. The off-line processing/manipulation may be effected using a personal digital assistant or mobile telephone, for example, or any other suitable device.

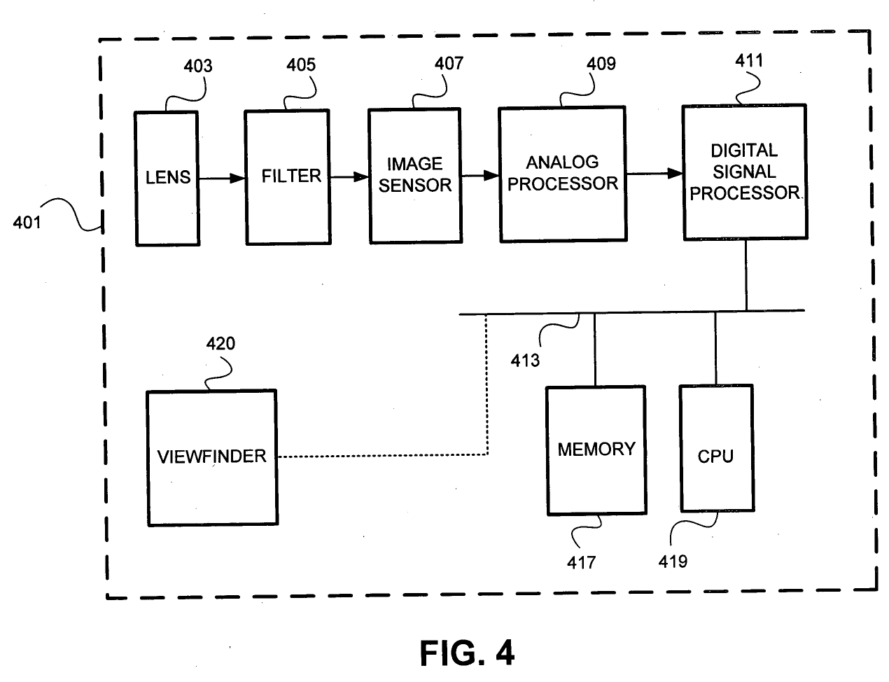

An image capture device 401 as shown in FIG. 4 comprises a lens assembly 403, a filter 405, image sensor 407, optional analogue processor 409, and a digital signal processor 411. An image or scene of interest is captured from light passing through the lens assembly 403. The light may be filtered using the filter 405. The image is then converted into an electrical signal by image sensor 407 which could be either of the devices mentioned above. The raw image data is then passed to the digital signal processor (DSP) 411.

Further, with reference to the device 401 of FIG. 4, a bus 413 is operable to transmit data and/or control signals between the DSP 411, memory 417, and the central processing unit (CPU) 419.

Memory 417 may be dynamic random-access memory (DRAM) and may include either non-volatile memory (e.g. flash, ROM, PROM, etc.) and/or removable memory (e.g. memory cards, disks, etc.). Memory 417 may be used to store raw image digital data as well as processed image digital data. CPU 419 is a processor operable to perform various tasks associated with the device 401.

It should be noted that there are many suitable alternative different configurations for the device of FIG. 4. In one embodiment, the CPU 419 and the DSP 411 may reside on a single chip, for example. In other embodiments, the CPU 419 and DSP 411 reside on two or more separate chips, for example. Further combinations are possible, but it should be noted that the exact architecture of the device 401 and/or the components therein as outlined above are not intended to be limiting.

The device of FIG. 4 includes the necessary functionality (either pre-programmed in the CPU 419 or in memory 417) in order to effect a reduction in a dimension, or dimensions, of a viewfinder field of view. Such a reduction, which occurs as a result of a device being placed into a particular image capture mode and/or a user selecting a specific reduction factor, may be effected by mechanical or electronic means.

In the case of an electronic reduction, the CPU 419, in association with the other elements of the device 401, is operable to mask a portion of the captured image data from a viewfinder field of view. The electronic reduction may be effected by addressing a smaller area in the viewfinder of the image data captured using an image capture element of the device. Other alternatives are possible.

In the case of a mechanical masking, the CPU 419 is operable to control the masking of a portion of the viewfinder field of view via the use of an optically opaque element or elements. Such an element or elements are operable to mask a portion of a viewfinder field of view. The masked viewfinder image is reduced in a dimension perpendicular to the direction of pan of the image capture device.

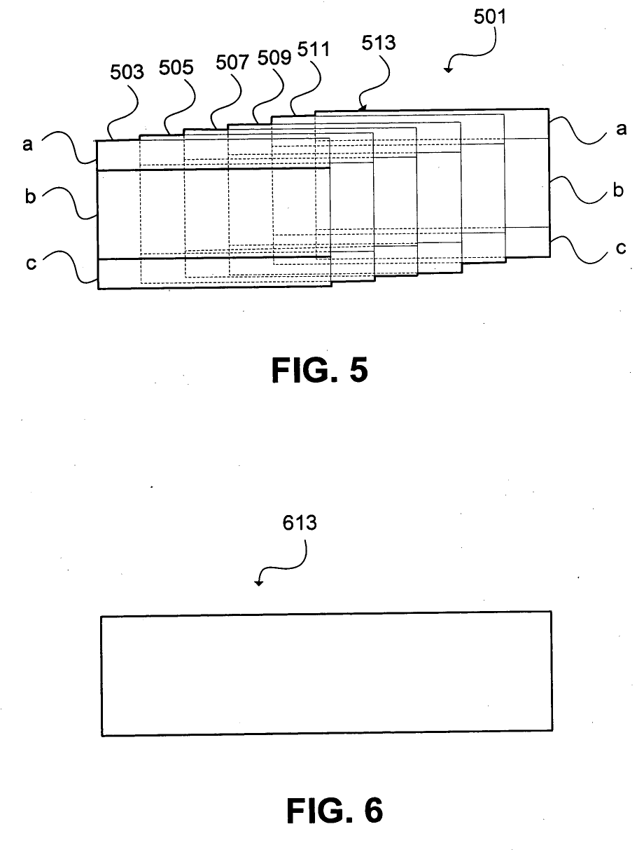

FIG. 5 of the accompanying drawings is a diagrammatic representation of a raw panoramic image obtained from a sequence of images captured using a suitable image capture device. The raw panoramic image is depicted as the bold line, and is ‘raw’ in the sense that no cropping has been performed on the image in order to generate a rectangular image.

The panoramic image 501 of FIG. 5 is composed from six separate images 503, 505, 507, 509, 511, and 513. It will be appreciated that the panorama 501 may be composed from more or less images than depicted in FIG. 5. Each image 503, 505, 507, 509, 511, and 513 comprises three regions a, b and c. Regions a and c of each image 503, 505, 507, 509, 511, and 513 are the areas which were completely masked in the viewfinder of a device, or presented in a viewfinder of the device at a reduced intensity. Areas b of the images 503, 505, 507, 509, 511, and 513 therefore represent the reduced visible viewfinder field of view of a device, and are the areas seen by a user of a device during image capture.

Images 503, 505, 507, 509, 511, and 513 have been aligned into a raw panoramic image as in FIG. 5 using known techniques. Such known techniques for stitching may rely on the identification of features within images as an aid to image alignment, for example. Other alternatives are possible.

Image areas a and c of each image, 503, 505, 507, 509, 511, and 513, may be stored in a memory of an image capture device using a different compression algorithm than areas b of the images 503, 505, 507, 509, 511, and 513. For example, areas a and c of images 503, 505, 507, 509, 511, and 513 may be stored in a memory of an image capture device using a more aggressive compression algorithm than the areas b of the images 503, 505, 507, 509, 511, and 513. For example, areas b of the images 503, 505, 507, 509, 511, and 513 may be stored in RAW format, whilst corresponding areas a and c may be stored as compressed image files in JPEG format.

FIG. 6 of the accompanying drawings is a diagrammatic representation of a panoramic image according to a preferred embodiment.

The area 613 of FIG. 6 represents the area of a fully defined rectangular panoramic image cropped from a raw panoramic image (such as that of FIG. 5) generated from a plurality of stitched images (not explicitly shown for clarity) using known methods.

By comparison with the panoramic image of FIG. 2, salient information relating to the top area of the panorama has been retained in the image of FIG. 6. More specifically, the use of a reduced viewfinder field of view of an image capture device means that, due to changed behaviour of the user induced by the masking, the problem of vertical drift has been reduced and the important top areas of the particular panoramic image in question have been retained.

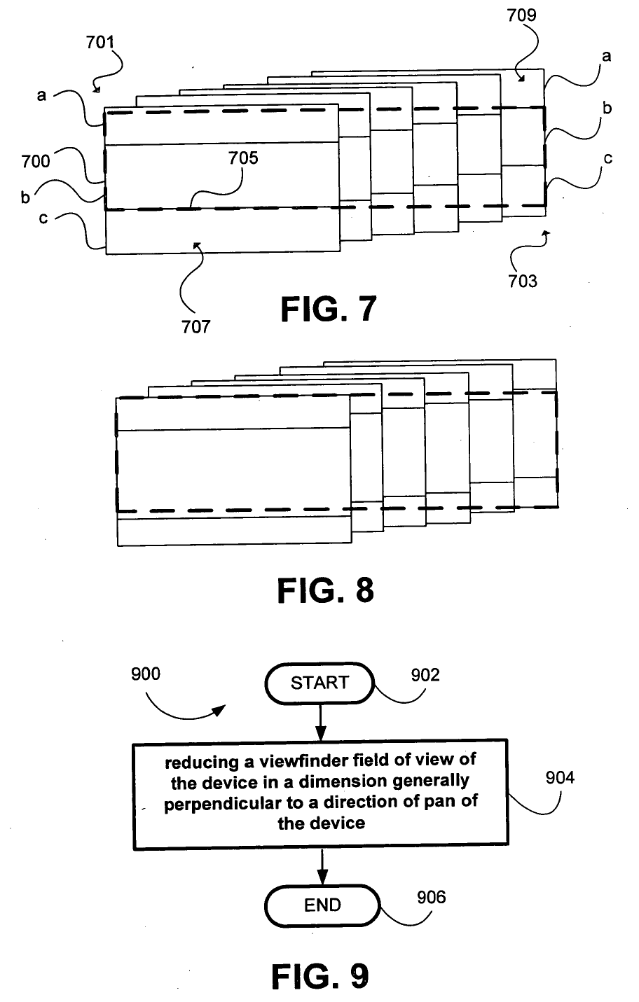

FIG. 7 of the accompanying drawings illustrates, diagrammatically, the way in which a rectangular panoramic image, such as that of FIG. 6, is obtained from a stitched plurality of images (such as those illustrated in FIG. 5) in accordance with the present device and method.

A suitably programmed microprocessor of an image capture device, such as that described above with reference to FIG. 4, is operable to crop a generated raw panorama in order to produce a rectangular panoramic image such as that shown in FIG. 6. More specifically, the processor is operable to produce a fully defined rectangular panoramic image which encompasses the areas corresponding to a reduced (limited) viewfinder field of view of the device, and more specifically, the areas b of the images of FIG. 7. An area of crop is depicted in the figure by the dashed rectangle 705.

The area defined by the dashed rectangle 705 encompasses the areas b of the images of FIG. 7, and hence the areas corresponding to the reduced viewfinder field of view of the device. The cropped panoramic image therefore includes the areas seen by a user of the device through the limited viewfinder field of view of the device, and hence includes the parts of a scene/object deemed salient by the user.

In order to produce such a cropped panoramic image, the processor is operable to determine, from the overall orientation of the stitched raw panorama, the upper and lower boundaries of the raw panoramic image as depicted by the image sides 701, 703. This may be accomplished by, for example, determining the direction of drift of the images making up the panorama, e.g. increasing vertical drift from left to right or vice-versa, for example. Alternatively, the image side 701 may be determined from the lowest point of the upper frame boundaries of the images comprising the raw panorama. Similarly, the image side 703 may be determined from the highest point of the lower frame boundaries.

In the example depicted in FIG. 7, there is a horizontally oriented raw panorama with an increasing upward vertical drift from left to right. Accordingly, the processor of a device will determine that sides 701 and 703 of the images 707, 709 represent the upper and lower boundaries for generating a maximal area rectangle within the stitched image data in which all pixels are defined such that the maximal area rectangle is not devoid of any image data.

The processor is then operable to generate the smallest rectangle which encompasses the areas b of the raw panorama in order to provide a reduced viewfinder panorama which is typically smaller (in area) than the maximal defined panorama. The reduced viewfinder panorama is therefore the rectangle of minimum area which encompasses the areas b, as shown by the dotted line in FIG. 7, and is, in general, the panoramic image that is desired by a user as it contains the salient material which was viewed using a reduced viewfinder field of view.

The image data within the reduced viewfinder panorama depicted in FIG. 7 is a fully defined rectangular panoramic image, and any peripheral image data outside the boundary defined by the rectangle defining the reduced viewfinder panorama may be discarded. For example, once such a panorama has been generated, each of the separate image data files from which the panorama was generated and the peripheral data from the generated panorama itself may be removed from a memory of the device.

It will be appreciated from the example of FIG. 7, that the generated rectangle defining the reduced viewfinder panorama encompasses the areas of the images associated with the reduced viewfinder field of view. In the case where such a generated reduced viewfinder panorama does not encompass these areas fully, as depicted in FIG. 8, several options are available to a user of a device operating in accordance with the present method.

If such a device, as described with reference to FIG. 4, has sufficient processing power and memory in order to be able to generate and manipulate image data as described above with reference to FIGS. 6 and 7, then such a device will include the necessary functionality in order to be able to stitch a sequence of images, and generate a raw panoramic image and/or a reduced viewfinder panorama. Accordingly, if it is determined by the device that a maximally defined rectangle 801 does not fully encompass all the areas of image data corresponding to a desired reduced viewfinder panorama, as depicted in FIG. 8, the device may warn the user that additional image data is required in order to produce a fully defined reduced viewfinder panoramic image.

Such a warning may take the form of a visual or audible warning or a combination of the two, for example. Alternatively, if the device detects that a situation such as that described above has occurred, and the device detects that it is not using the widest possible angle zoom setting of the lens of the device, it may warn a user that this is the case using the visual or audible warning or a combination of the two, and recommend that the images used to generate a panorama are re-captured using the widest lens angle zoom setting of the device.

Following the warning, or alternatively, in place of a warning, the device may recommend that in order to generate a fully defined panorama, a multi-swath capture may be performed. In this manner, a user may perform a double (or more) ‘sweep’ of the object/scene to be captured in order to ensure that enough image data is captured in order for the device to be able to generate a fully defined reduced viewfinder panoramic image.

Alternatively, a user of the device may use the failed reduced viewfinder panorama as a template. Accordingly, the device may display any captured images in a display of the device, and highlight areas where additional image data is required. A user of the device may then be able to capture additional images. As an aid to alignment, the already captured images around the areas where additional data is required may serve as an alignment guide.

Further alternatively, a user may capture all of the relevant images again using the failed reduced viewfinder panorama as a template. In this connection, the failed reduced viewfinder panorama may be displayed on a display of the device as a capture aid for a user.

In a further embodiment, the device is operable to stitch images as they are captured, and a warning may therefore be issued during the capture process in order to advise a user of the device that a reduced viewfinder panorama generated using the images captured up to that point will contain undefined regions, if this is the case. More specifically, if the device determines that a generated reduced viewfinder panorama will not encompass the areas corresponding to the reduced viewfinder field of view when it is generated (and hence not include all the salient material), it may issue a warning, and a user may compensate by capturing additional images, or by adjusting the areas subsequently captured if this is sufficient to overcome the problem. The device may continue to issue such a warning until the situation has been rectified. In this connection, the device may display the images already captured up to the point the warning was issued in the form of a stitched sequence in order that they may serve as an aid to the user in determining which areas of the desired panorama require additional image data.

It will be appreciated, that when a device is operable to display a captured sequence of images to a user, either in the form of a plurality of distinct images, or as a generated panoramic image, such a display may be effected using the images at a different resolution to that at which they were actually captured by the device. More specifically, and with particular reference to a device with an electronic image capture element, a device may display images to a user at a lower resolution than that at which they were captured.

In addition, when the device is operable to manipulate images, such as when the device is generating a panoramic image from a plurality of captured images for example, such manipulation may be performed by the device using images which are at a lower resolution than that at which they were originally captured. This will therefore enable a device to perform such manipulation at a much faster rate than if higher resolution images were used, and therefore display such generated images to a user at a much faster rate than if higher resolution images were used for the manipulation. Once it comes to producing a final panoramic image for output from the device, for example, then the originally captured higher resolution images may be used.

FIG. 9 is a flow chart 900 of a process employed by various embodiments. The process starts at block 902. At block 904, a viewfinder field of view of the device is reduced in a dimension generally perpendicular to a direction of pan of the device. The process ends at block 906.

1. An image capture device having a panorama mode for processing images captured using a panoramic sweep of the device, in which mode an extent of a capturable image presented for viewing by a user is limited laterally of an axis of intended sweep.

2. A device as claimed in claim 1, wherein, in said panorama mode, a plurality of sequential image frames are captured during the panoramic sweep such that portions of the adjacent captured image frames overlap.

3. A device as claimed in claim 1, wherein, in said panorama mode, a plurality of images captured using a second panoramic sweep of the device are processed with the images captured with the first panoramic sweep, in which mode the same extent of the capturable image is presented for viewing.

4. A device as claimed in claim 1, wherein, in said panorama mode, the extent of the capturable image presented for viewing by the user is limited parallel to the axis of intended sweep.

5. A device as claimed in claim 1, wherein said capturable image is presented for viewing by the user using a viewfinder of the device.

6. A device as claimed in claim 5, operable to limit said extent using a viewfinder zoom of the device.

7. A device as claimed in claim 5, operable to limit said extent using a mechanical mask operable to obscure at least a portion of the viewfinder.

8. A device as claimed in claim 5, operable to capture image data using an image capture element of the device, wherein a viewfinder field of view is reduced by limiting an amount of captured image data presented for viewing by the user.

9. A device as claimed in claim 1, further including a microprocessor operable to generate a panoramic image from captured image data.

10. A device as claimed in claim 9, wherein the microprocessor is further operable to generate the panoramic image from said captured image data which encompasses only image data which was available for view in a viewfinder field of view presented for viewing by the user of the device.

11. A device as claimed in claim 9, wherein the microprocessor is operable to determine that blank areas devoid of image data are present in a generated panoramic image.

12. A device as claimed in claim 9, comprising automatic warning means operable to warn the user of panoramic image generation failure.

13. A device as claimed in claim 12, wherein said automatic warning means includes at least one of an audible alarm and a visual alarm.

14. A device as claimed in claim 12, wherein said automatic warning means is activated by said microprocessor in the event that a generated panoramic image contains blank areas devoid of image data.

15. A device as claimed in claim 12, wherein said automatic warning means is activated by said microprocessor in the event that at least a portion of the image data which was available for view in a viewfinder field of view presented for viewing by the user of the device is outside of the area defined by the generated panorama image.

16. A device as claimed in claim 8, wherein said image capture element is a charge-coupled device or a complementary metal oxide semiconductor device.

17. A device as claimed in claim 9, wherein said microprocessor is further operable to present a generated panoramic image for viewing by the user.

18. A device as claimed in claim 1, wherein said device is operable to adjust the intensity of at least a portion of a capturable image presented for viewing by the user.

19. A method of using an image capture device, the method comprising reducing a viewfinder field of view of the device in a dimension generally perpendicular to a direction of pan of the device.

20. A method as claimed in claim 19, further including reducing the viewfinder field of view of the device in a dimension generally parallel to the direction of pan of the device.

21. A method as claimed in claim 19, wherein the viewfinder field of view is reduced by applying a mechanical mask to the viewfinder view.

22. A method as claimed in claim 19, wherein image data is captured using an image capture element of the device and the viewfinder field of view is reduced by reducing an amount of image data available for view in the viewfinder of the device.

23. A method as claimed in claim 22, wherein reducing the amount of image data available for view in the viewfinder of the device is effected by electronically masking a portion of a viewfinder image.

24. A method as claimed in claim 19, wherein the intensity of at least one portion of the image data available for view in the viewfinder of the device is reduced with respect to the rest of the image data available for viewing in the viewfinder of the device.

25. A method as claimed in claim 19, wherein the viewfinder field of view is reduced using a viewfinder zoom of the device.

26. A method as claimed in claim 19, further including generating a panoramic image from at least two images captured using a device with a reduced viewfinder field of view.

27. A method as claimed in claim 19, further including generating a panoramic image from at least two images captured using a device with a reduced viewfinder field of view, which generated image encompasses only image data which was available for view in the viewfinder field of view presented for viewing by the user of the device.

28. An image capture device including a panoramic image generation mode, said device including means for limiting an extent of a capturable image presented for viewing by a user laterally of an axis of intended sweep when the device is in said panoramic image generation mode.

29. A method of using an image capture device having a panorama mode in which mode an extent of a capturable image adapted to be presented for viewing by a user is limited laterally of an axis of intended sweep, the method including processing images captured using a panoramic sweep of the device.

30. An image capture device having a panorama mode for processing a plurality of sequentially captured images, the images captured during a plurality of corresponding sequential positions of the image capture device, in which mode an extent of a capturable image presented for viewing by a user is limited laterally of an axis corresponding to a direction of movement of the image capture device.

31. A device as claimed in claim 30, wherein the direction of movement of the image capture device during sequential capture of the images corresponds to a panoramic sweep of the image capture device.

32. A device as claimed in claim 30, further comprising a viewfinder that presents the extent of the capturable image for viewing by the user.

33. A device as claimed in claim 30, wherein, in said panorama mode, the plurality of sequential captured images overlap portions of adjacent captured images.
